(19) United States
(12) Patent Application Publication
(10) Pub. No.: US 2017/0006263 A1
(43) Pub. Date: Jan. 5, 2017

(54) CAMERA UNIT ADAPTED TO BE PLACED ON BOARD A DRONE TO MAP A LAND AND A METHOD OF IMAGE CAPTURE MANAGEMENT BY A CAMERA UNIT

(71) Applicant: PARROT DRONES, Paris (FR)

(72) Inventor: Eng Hong Sron, Paris (FR)

(21) Appl. No.: 15/189,676

(22) Filed: Jun. 22, 2016

(30) Foreign Application Priority Data
Jun. 30, 2015 (FR) 1556143

(51) Int. Cl. H04N 7/18; B64C 39/02; B64D 47/08; G06K 9/00

(52) U.S. Cl. CPC H04N 7/188; H04N 7/183; G06K 9/00657; B64C 39/024; B64D 47/08; B64C 2201/123

(57) ABSTRACT

The invention relates to a camera unit (14) adapted to be placed on board a drone (10) to map a land (16), comprising a camera (18) adapted to capture successive images of portions of the land overflown by the drone. The camera unit comprises means for memorizing the captured images, means for comparing information about the overflown land portion visible through the camera with at least one piece of information about at least the previous captured image to determine the rate of overlapping of the overflown land portion with at least said previous captured image, and means for sending a command to the camera to carry out the capture of an image, as soon as the rate of overlapping of the overflown land portion is lower than or equal to the predetermined rate of overlapping.

The invention relates to the drones for mapping a land, but more particularly a camera unit adapted to be placed on board a drone.

The AR.Drone 2.0, the Bebop Drone of Parrot SA, Paris, France or the eBee of SenseFly SA, Suisse, are typical examples of drones. They are equipped with a series of sensors (accelerometers, 3-axis gyrometers, altimeter) and at least one camera. This camera is for example a vertical-view camera capturing an image of the overflown land. These drones are provided with a motor or with several rotors driven by respective motors adapted to be controlled in a differentiated manner so as to pilot the drone in attitude and speed.

The invention more particularly relates to a camera unit adapted to be placed on board a drone for mapping a land, in particular crop fields. These camera units are for example equipped with a multi-spectral photo sensor in order to measure the reflectance of the crops, i.e. the quantity of light reflected by the leaves, in order to obtain pieces of information about the state of the photosynthesis.

In order to map a land, these drones fly through the land and carry out a succession of image captures.

Once the image capture carried out, these images are processed to make a 2D or 3D map of the overflown zone, in particular so as to obtain the characteristics of the crops observed.

These drones are controlled during the flying over of the land to be mapped via a control device or through the loading of a trajectory along which the drone will fly autonomously.

The mapping of a land is carried out by the successive triggering of the camera equipping the drone.

To carry out these successive captures, it is known to establish a particular communication between the drone and the camera, the drone determining the successive times for the triggering of the camera and the carrying out of the image captures.

This solution has for drawback to be dependent on the protocol of communication between the cameras and the drone imposed by the drone manufacturer. To date, no standard of communication being defined, the cameras are then developed specifically for each drone manufacturer. Another known solution is to carry out, during the flight of the drone, a capture of image of the overflown land at regular time intervals, in particular every “X” seconds. In order to be adapted to create a complete map of the overflown land, a great quantity of images must be captured. It is known in particular from the document US 2013/135440 an image capture device such as a camera for capturing images at predetermined time intervals.

This solution has hence for drawback to require memorizing and processing a significant volume of images. Moreover, more images than necessary for this mapping are generated, which has for drawback to require a great storage capacity and heavy processing operations for building the map of the overflown zone.

The object of the present invention is to remedy these drawbacks, by proposing a solution allowing a full mapping of the land to be mapped while minimizing the number of image acquisitions to be carried out.

For that purpose, the invention proposes a camera unit to be placed on board a drone, for mapping a land, comprising un camera adapted to capture successive images of portions of the land overflown by the drone.

Characteristically, it is provided that the camera unit comprises means for memorizing the captured images, means for comparing information about the overflown land portion visible through said camera with at least one piece of information about at least the previous captured image to determine the rate of overlapping of the overflown land portion with at least said previous captured image, and means for sending a command to the camera to carry out the capture of an image, as soon as the rate of overlapping of the overflown land portion is lower than or equal to the predetermined rate of overlapping.

According to a particular embodiment, the camera is a vertical-view camera pointing downward.

In a particular embodiment, the comparison means operate a comparison with at least one piece of capture context information about a land portion.

In particular, the camera unit may comprise means for generating at least one piece of capture context information about an overflown land portion, and the memorizing means are adapted to memorize the context information associated with said captured images, and the comparison means are adapted to compare at least one piece of context information about the overflown land portion generated by the means for generating context information with at least one piece of context information memorized of at least the previous captured image to determine the rate of overlapping of the overflown land portion with at least the previous captured image.

According to an embodiment, the comparison means operate a comparison with a piece of geolocation information and/or the speed of displacement of the camera unit and/or the angle of view of the camera and/or the orientation of the camera and/or the distance between the camera and the ground.

According to a particular embodiment, the camera unit further comprises a device for estimating the altitude of said camera unit and means for memorizing the initial distance between the camera and the ground determined by said altitude estimation device before the take-off of the drone, and the distance between the camera and the ground of the overflown land portion is determined by the difference between the initial distance and the distance determined by the altitude estimation device of said camera unit during the flying over of the land portion.

According to a particular embodiment, the camera unit further comprises a device for analysing the images of the camera adapted to produce a horizontal speed signal, derived from an analysis of the speed of displacement of the captured land portion from one image to the following one, and the distance between the camera and the ground is further function of said horizontal speed signal.

According to a particular embodiment, the means for sending a command operate a sending of a command to the camera as soon as the rate of overlapping is of at most 85% and preferentially of at most 50%.

The invention also proposes a drone for mapping a land comprising a camera unit according to one of the above-described embodiments.

According to another aspect, the invention proposes a method of image capture management by a camera unit adapted to be placed on board a drone to map a land, the camera unit comprising a camera adapted to capture successive images of portions of the land overflown by the drone.

Characteristically, the method comprises the following steps: a step of comparing information about the overflown land portion visible through said camera with at least one piece of information about at least the previous captured image to determine the rate of overlapping of the overflown land portion with at least said previous captured image, and a step of sending a command to the camera to carry out the capture of an image, as soon as the rate of overlapping of the overflown land portion is lower than or equal to the predetermined rate of overlapping.

According to a particular embodiment, said piece of information corresponds to at least one piece of capture context information about a land portion.

According to another embodiment, the method further comprises a step of generating at least one piece of capture context information about an overflown land portion, and the comparison step compares said at least one piece of context information about the overflown land portion with at least one memorized piece of context information about at least the previous captured image to determine the rate of overlapping of the overflown land portion with at least said previous captured image.

Advantageously, the method further comprises a step of memorizing the captured image and its context information generated during the step of generating at least one piece of context information about the overflown land portion.

According to an embodiment, the piece of context information comprises a piece of geolocation information and/or the speed of displacement of the camera unit and/or the angle of view of the camera and/or the orientation of the camera and/or the distance between the camera and the ground.

According to the embodiment, the method further comprises, before the take-off of the drone, a step of determining the initial distance between the camera and the ground by estimating the altitude of said camera unit, and during the flight of the drone, at least one step of determining the distance between the camera and the ground of the overflown land portion by difference between the initial distance and the estimated distance of the altitude of said camera unit.

According to an alternative embodiment, the method further comprises a step of analysing the images of the camera to produce a horizontal speed signal, derived from an analysis of the displacement of the captured land portion from one image to the following one, and a step of determining the distance between the camera and the ground as a function of said horizontal speed signal.

According to a particular embodiment of the method, the predetermined rate of overlapping is at most of 85% and preferentially of at most 50%.

An exemplary embodiment of the present invention will now be described, with reference to the appended drawings.

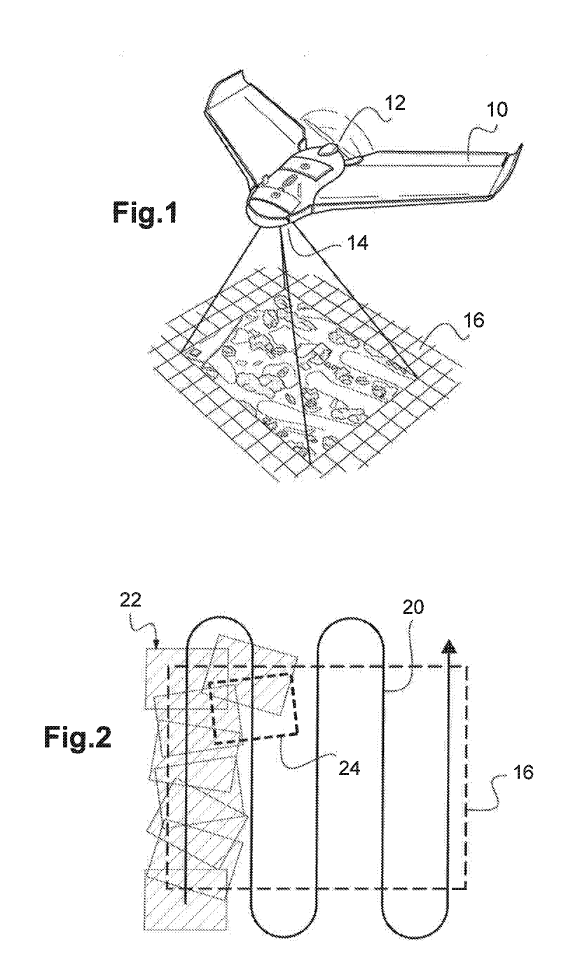

FIG. 1 illustrates a drone and a land to be mapped.

FIG. 2 illustrates an example of trajectory along which the drone must fly to map the land and an illustration of a succession of captured images and the following image to be captured, according to the invention.

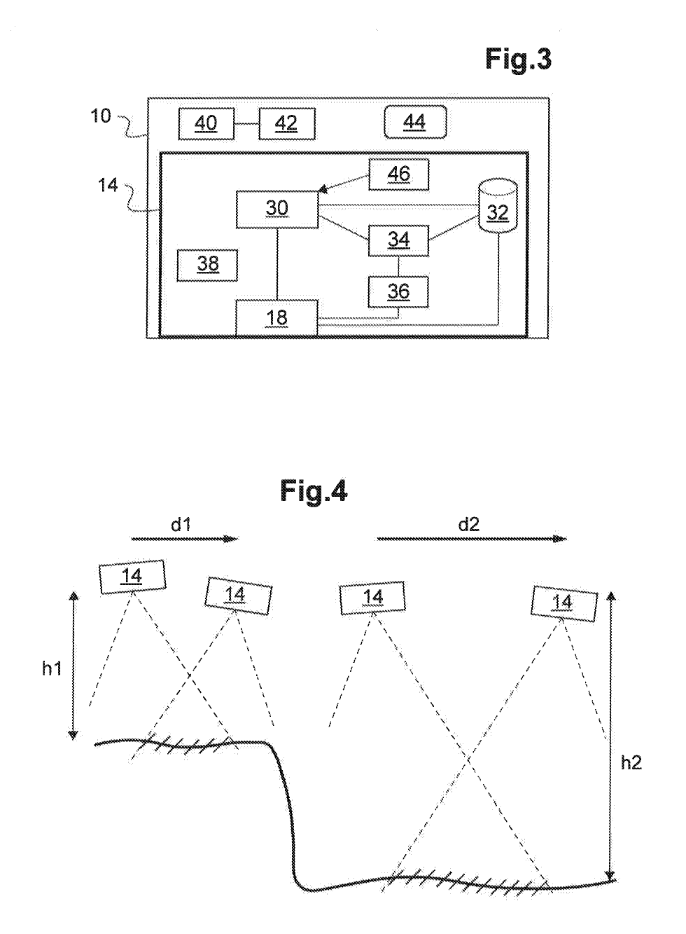

FIG. 3 illustrates a structure of the camera unit according to the invention, placed for example on board a drone.

FIG. 4 shows the route on a land having a great difference of levels.

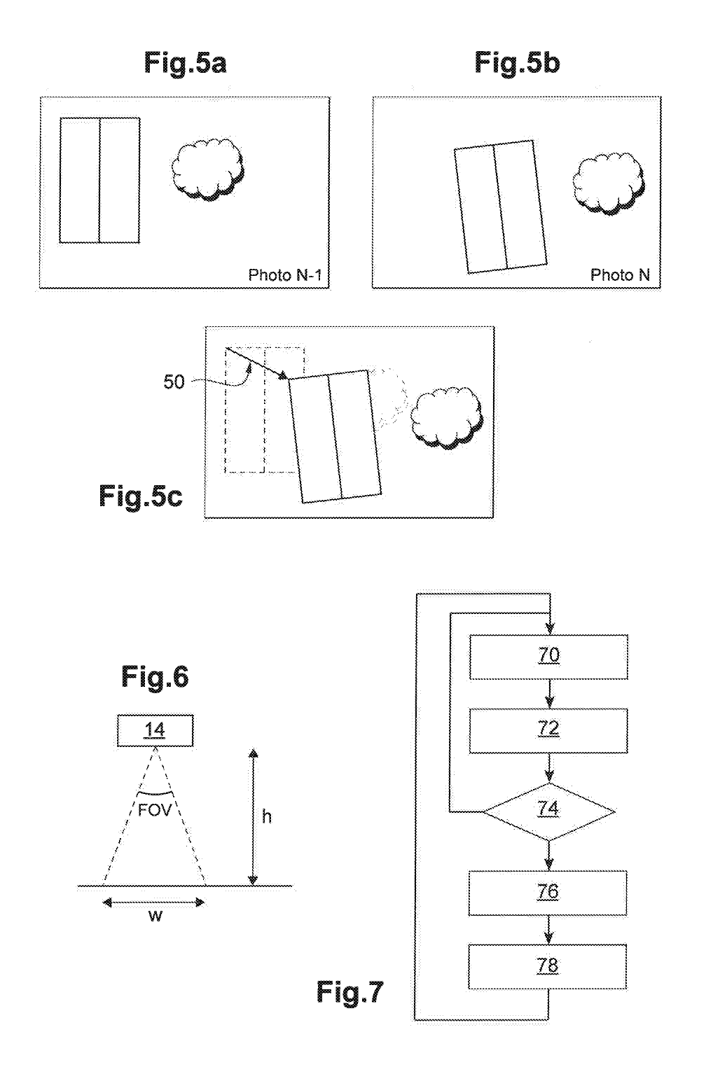

FIGS. 5a and 5b show the captured image N-1 and the captured image N and FIG. 5c illustrates the superimposition of the images N-1 and N.

FIG. 6 is a diagram illustrating different parameters allowing the determination of an image context.

FIG. 7 is a method of image capture management by a camera unit according to the invention.

An exemplary embodiment of the invention will now be described.

In FIG. 1, the reference 10 generally denotes a drone. According to the example illustrated in FIG. 1, it is a sailwing such as the eBee model of SenseFly SA, Suisse. This drone includes a motor 12.

According to another exemplary embodiment, the drone is a quadricopter such as the Bebop Drone model of Parrot SA, Paris, France. This drone includes four coplanar rotors whose motors are piloted independently by an integrated navigation and attitude control system.

The drone 10 is provided with an on-board camera unit 14 allowing to obtain a set of images of the land to be mapped 16, the drone flying over this land.

According to the invention, the camera unit 14 is autonomous, in particular, it is adapted to operate independently from the drone. In other terms, the camera unit uses no information coming from sensors integrated to the drone. That way, no communication means are to be provided between the drone and the camera unit, the latter being hence adapted to be installed in any drone.

For that purpose, the drone 10 comprises a cavity intended to receive the camera unit 14.

According to the invention, the camera unit 14 comprises a camera 18, for example a high-definition wide-angle camera, with a resolution of 12 Mpixel or more (20 or 40 Mpixel), typically of CMOS technology with a resolution of 1920×1080 pixels, adapted to capture successive images of portions of the land 16 overflown by the drone. These images are for example RGB (Red-Green-Blue) images in all the colours of the spectrum.

We call “land portion” a part of the overflown land visible by the camera of the on-board camera unit 14.

According to a particular embodiment, the camera unit 14 is a vertical view camera pointing downward.

The camera unit 14 may further be used to evaluate the speed of the drone with respect to the ground.

According to an exemplary embodiment, the drone adapted to receive the camera unit 14 on board is provided with inertial sensors 44 (accelerometers and gyrometers) for measuring with a certain accuracy the angular speeds and the angles of attitude of the drone, i.e. the Euler angles (pitch φ, roll θ and yaw ψ describing the inclination of the drone with respect to a horizontal plane of a fixed terrestrial reference system UVW, it being understood that the two longitudinal and transverse components of the horizontal speed are intimately linked to the inclination according to the two respective pitch and roll axes.

According to a particular embodiment, the camera unit 14 is also provided with at least one inertial sensor described hereinabove.

According to a particular embodiment, the drone 10 is piloted by a remote-control apparatus such as a touch-screen multimedia telephone or tablet having integrated accelerometers, for example a smartphone of the iPhone type (registered trademark) or else, or a tablet of the iPad type (registered trademark) or else. It is a standard apparatus, not modified except the loading of a specific applicative software to control the piloting of the drone 10. According to this embodiment, the user controls in real time the displacement of the drone 10 via the remote-control apparatus.

According to another embodiment, the user defines, via un remote-control device, a route to be followed, then sends the route information to the drone so that the latter follows this route.

The remote-control apparatus communicates with the drone 10 via a bidirectional exchange of data via wireless link of the Wi-Fi (IEEE 802.11) or Bluetooth (registered trademarks) local network type.

According to the invention, in order to be able to create a 2D or 3D map of a land to be mapped, in particular an agricultural crop field, which is exploitable and of very good quality, the successive images captured by the camera unit placed on board the drone must have between each other a significant zone of overlapping. In other words, each point of the land must be captured by several images.

FIG. 2 illustrates a land to be mapped 16 that is flown over by a drone following a route 20. A succession of images 22 captured by the camera unit 14 is shown, each image having a significant rate of overlapping with the previous image. This rate of overlapping must be of at least 50% and preferably of at least 85%.

The rate of overlapping is for example the number of pixels in common with at least two images.

In dotted lines in FIG. 2 is illustrated the following image to be captured 24 by the camera unit 14, this image having a significant rate of overlapping with the previous image in the direction of displacement of the drone and with another captured image.

For that purpose, as illustrated in FIG. 3, the drone 10 comprises a camera unit 14 according to the invention.

Furthermore, the drone may comprise means for receiving a flight command 40 according to a determined route and means for controlling the flight 42 according to said route.

The camera unit 14 according to the invention further comprises means 32 for memorizing the captured images, means 34 for comparing information about the overflown land portion visible through the camera 18 with at least one piece of information about at least the previous captured image to determine the rate of overlapping of the overflown land portion with at least said previous captured image, and means 36 for sending a command to the camera 18 to carry out the capture of an image, as soon as the rate of overlapping of the overflown land portion is lower than or equal to the predetermined rate of overlapping.

Hence, according to the invention, the camera unit 14 compares a piece of information relative to the overflown land portion, for example a view of the land portion obtained by the camera 18 of the camera unit 14 with at least one piece of information about the previous captured image, for example, the previous memorized image.

This comparison allows determining the size of the zone of overlapping between at least the previous captured image and the overflown land portion visible by the camera, hence defining the rate of overlapping.

The piece of information relative to an overflown land portion is for example a low-resolution image or a high-resolution image of the land portion, or any other piece of information relative to the land portion.

In particular, the piece of information may correspond to at least one piece of capture context information about a land portion.

According to a particular embodiment, the camera unit 14 further comprises, as illustrated in FIG. 3, means for generating at least one piece of capture context information 30 about a land portion.

More precisely, according to an embodiment, the memorizing means 32 are adapted to memorize the piece of context information associated with said captured images, and the comparison means 34 are adapted to compare at least one piece of context information about the overflown land portion generated by the means for generating a piece of context information 30 with at least one memorized piece of context information about at least the previous captured image to determine the rate of overlapping of the overflown land portion with at least the previous captured image.

According to the information, to allow a construction of good quality of the land map while minimizing the number of image captures, the predetermined rate of overlapping is at least 85% and preferentially at least 55%.

Such a rate of overlapping between at least two successive images allows having several images having captured a same point of the land to be mapped.

Each captured image is memorized in the memorizing means 32 with at least one piece of capture context information.

The means 30 for generating a piece of context information of the camera unit are adapted to generate a piece of context information as, for example:
a piece of geolocation information obtained by a geolocation system or GPS device integrated to the camera unit 14 and/or
the speed of displacement of the camera unit 14 and/or
the angle of view of the camera and/or
the orientation of the camera and/or
the distance h between the camera and the ground.

The means 30 for generating a piece of context information generate a piece of context information, for example, from a piece of information emitted by one or several sensors 46 integrated to the camera unit 14, as illustrated in FIG. 3.

According to another embodiment, these means 30 for generating a piece of context information generate a piece of context information from information determined via the captured images.

The context information used and memorized during the making of a mapping may be dependent on the configuration of the land to be mapped.

In the case, for example, of a land to be mapped that is relatively flat, i.e. having a small difference of levels, a piece of geolocation information may be used as a single piece of context information.

According to this example, the comparison means 34 of a camera unit 14 compare the geolocation information of at least the previous image captured and memorized with the geolocation information generated by the geolocation system integrated to the camera unit 14. From this comparison, the means 34 define a rate of overlapping between the previous captured image and the land portion viewed by the camera. If the rate of overlapping of the overflown land portion determined by the comparison means is lower than or equal to the predetermined rate of overlapping, then the means 36 for sending a command will send a command to the camera for the capture of the image.

This captured image will be memorized by the memorization means 32 with its piece of context information generated by the means 30.

The context information in such a land configuration may also correspond to the distance h between the camera and the ground.

According to another example, when the land has differences of levels, in particular great differences of levels, the context information about the images must comprise a plurality of data so as to be able to determine a real rate of overlapping between at least the previous image captured and memorized and the new overflown land portion.

FIG. 4 illustrates a land 16 having a great difference of levels. As viewed hereinabove, in such a situation, a plurality of pieces of context information must be memorized during the capture of an image, in particular to as to be able to determine the following image to be captured as soon as the real rate of overlapping is lower than or equal to the predetermined rate of overlapping.

In such a context, the context information must comprise in particular the speed of displacement of the camera unit 14, the angle of view of the camera 14, the orientation of the camera 14 and the distance h between the camera and the ground.

The orientation of the camera 14 is, for example, determined from the information emitted by at least one of the following sensors 46: gyrometer, accelerometer or magnetometer located on board the camera unit 14.

The distance h between the camera and the ground may be determined according to different methods implemented, wherein the method used can be determined in particular as a function of the configuration of the land to be mapped.

When the land to be mapped is relatively flat, i.e. the difference of levels of the land is negligible, then the method of calculation of the distance h between the camera and the ground comprises a previous step of determining this distance h, called initial distance, carried out before the take-off of the drone.

The initial distance h between the camera and the ground is memorized via memorization means in the camera unit 14, this distance h is determined by a device 38 for estimating the altitude of camera unit 14, placed on board the camera unit, as illustrated in FIG. 3.

This device 38 comprises for example an altitude estimator system based on measurements of a barometric sensor and an ultrasound sensor as described in particular in the document EP 2 644 240 in the name of Parrot SA.

Then, this method comprises a step of determining the distance between the camera and the ground of the overflown land portion by making the difference between the memorized initial distance and the determined distance between the camera and the ground of the overflown land portion, also called current camera—ground distance, by the altitude estimation device 38 of the camera unit 14.

However, when the relief of the land to be mapped is significant, a second method of determining the distance between the camera and the ground is preferred.

This second method comprises a step of analysing the images of the camera to produce a horizontal speed signal, derived from an analysis of the speed of displacement of the captured land portion from one image to the following one, this speed of displacement being determined for example in pixels.

For that purpose, the camera unit 14 further comprises a device for analyzing the images of the camera adapted to produce a horizontal speed signal, derived from an analysis of the displacement of the captured land portion from one image to the following one.

FIGS. 5a and 5b illustrate two successive images N-1 and N and FIG. 5c illustrate the superimposition of the images N-1 and N.

From these two images, it is possible to determine the speed of displacement of the camera unit in pixels Vₚᵢₓ shown by the arrow 50 in FIG. 5c.

FIG. 6 illustrates the different parameters used for determining the distance between the camera and the ground.

The distance h between the camera and the ground is then determined as follows:

$$\frac{w}{2 h} = tan ( \frac{FOV}{2} )$$

w being the width of the land portion visible by the vertical camera FOV being the angle of view

$$Résolution = \frac{w}{{w}_{pix}}$$

with Wₚᵢₓ the number of pixels of the vertical-view camera. or

$$Résolution = \frac{v}{{v}_{pix}}$$

It is hence deduced that the distance h between the camera and the ground is determined according to the equation:

$$h = \frac{v , {w}_{pix}}{2 {v}_{pix} \cdot tan ( \frac{FOV}{2} )}$$

The method of image capture management by a camera unit adapted to be placed on board a drone 10 to map a land 16 according to the invention is now illustrated in FIG. 7, the camera unit 14 comprising a camera 18 adapted to capture successive images of portions of the land overflown by the drone.

The method of image capture management by a camera unit 14 to map a land 16 comprises in particular the following steps:
a step 72 of comparing information about the overflown land portion visible through the camera 18 with at least one piece of information about at least the previous captured image to determine the rate of overlapping of the overflown land portion with at least said previous captured image, and
a step 76 of sending a command to the camera to carry out the capture of an image, as soon as the rate of overlapping of the overflown land portion is lower than or equal to the predetermined rate of overlapping.

Hence, according to the invention, the method carries out a comparison of a piece of information relative to the overflown land portion, for example a view of the land portion with at least one piece of information about the previous captured image, for example, the previous memorized image.

As viewed hereinabove, the information relative to an overflown land portion is for example a low-resolution image or a high-resolution image of the land portion, or any other piece of information relative to the land portion

In particular, the information may correspond to at least one piece of capture context information about a land portion.

According to a particular embodiment of said method, the latter comprises a step 70 of generating at least one piece of context information about the overflown land portion. This step allows identifying the context of the camera unit 14 during the flying over of the land, for example the geolocation of the camera unit and/or the speed of displacement of the camera unit and/or the angle of view of the camera and/or the orientation of the camera and/or the distance between the camera and the ground.

The step 70 is followed by a step 72 of comparing said at least one piece of context information about the overflown land portion with at least one memorized piece of context information, in particular by the means 32 for memorizing at least the previous captured image to determine the rate of overlapping of the overflown land portion with at least said previous captured image.

The step allows comparing indirectly the image of the land portion that is being overflown by the drone 10 with the previously captured image, or even also with other captured images. Then, this step determines the rate of overlapping of the land portion that is being overflown with at least the previous captured image.

After having determined the rate of overlapping, the method continues at step 74 of comparing the rate of overlapping of the overflown land portion with a predetermined rate of overlapping.

Indeed, in order to determine from one or several captured and memorized images, the following image to be captured, it must be determined if the new positioning of the camera unit after its displacement allows discovering a new portion of the land to be mapped while having a predetermined rate of overlapping with one or several still captured and memorized images.

If, at step 74, the rate of overlapping of the overflown land portion is higher than the predetermined rate of overlapping, then the method continues at step 70 by the generation of at least one new piece of context information about the new overflown land portion.

In the contrary case, i.e. the rate of overlapping of the overflown land portion is lower than or equal to the predetermined rate of overlapping, then step 74 continues at step 76 of sending a command to the camera to carry out the capture of an image.

Step 76 is followed with a step 78 of memorization of the captured image and of its context information generated during step 70 of at least one piece of context information about the overflown land portion.

Step 78 is then followed by the above-described step 70 in order to proceed to the determination of the following image to be captured.

These different steps are executed until the captures of images of the whole land to be mapped are made.

1. A camera unit (14) adapted to be placed on board a drone (10), to map a land (16), comprising a camera (18) adapted to capture successive images of portions of the land overflown by the drone, characterized in that it comprises
means (32) for memorizing captured images,
means (34) for comparing information about the overflown land portion visible through said camera with at least one piece of information about at least the previous captured image to determine the rate of overlapping of the overflown land portion with at least said previous captured image, and
means (36) for sending a command to the camera to carry out the capture of an image, as soon as the rate of overlapping of the overflown land portion is lower than or equal to the predetermined rate of overlapping.

2. The camera unit according to claim 1, characterized in that the comparison means operate a comparison with at least one piece of capture context information about a land portion.

3. The camera unit according to claim 1, characterized in that it comprises means (30) for generating at least one piece of capture context information about an overflown land portion, and in that:
the memorizing means (32) are adapted to memorize the context information associated with said captured images, and
the comparison means (34) are adapted to compare at least one piece of context information about the overflown land portion generated by the means for generating a piece of context information with at least one memorized piece of context information about at least the previous captured image to determine the rate of overlapping of the overflown land portion with at least the previous captured image.

4. The camera unit according to claim 2, characterized in that the comparison means operate a comparison with a piece of geolocation information and/or the speed of displacement of the camera unit and/or the angle of view of the camera and/or the orientation of the camera and/or the distance between the camera and the ground.

5. The camera unit according to claim 4, characterized in that it further comprises:
a device for estimating the altitude of said camera unit (38), and
means for memorizing the initial distance between the camera and the ground determined by said altitude estimation device before the take-off of the drone, and in that the distance between the camera and the ground of the overflown land portion is determined by the difference between the initial distance and the distance determined by the altitude estimation device of said camera unit during the flying over of the land portion.

6. The camera unit according to claim 5, characterized in that it further comprises a device for analysing the images of the camera adapted to produce a horizontal speed signal, derived from an analysis of the speed of displacement of the land portion captured from one image to the following one, and in that the distance between the camera and the ground is further function of said horizontal speed signal.

7. The camera unit according to claim 1, characterized in that the means for sending a command operate a sending of a command to the camera as soon as the rate of overlapping is at most of 85% and preferentially of at most 50%.

8. A drone (10) to map a land (16) comprising a camera unit (14) adapted to be placed on board a drone (10), to map a land (16), comprising a camera (18) adapted to capture successive images of portions of the land overflown by the drone, characterized in that it comprises
means (32) for memorizing captured images,
means (34) for comparing information about the overflown land portion visible through said camera with at least one piece of information about at least the previous captured image to determine the rate of overlapping of the overflown land portion with at least said previous captured image, and
means (36) for sending a command to the camera to carry out the capture of an image, as soon as the rate of overlapping of the overflown land portion is lower than or equal to the predetermined rate of overlapping.

9. A method of image capture management by a camera unit adapted to be placed on board a drone (10) to map a land (16), the camera unit comprising a camera (18) adapted to capture successive images of portions of the land overflown by the drone, characterized in that the method comprises the following steps:
a step (72) of comparing information about the overflown land portion visible through the camera with at least one piece of information about at least the previous captured image to determine the rate of overlapping of the overflown land portion with at least said previous captured image, and
a step (76) of sending a command to the camera to carry out the capture of an image, as soon as the rate of overlapping of the overflown land portion is lower than or equal to the predetermined rate of overlapping.

10. The method according to claim 9, characterized in that said information corresponds to at least one piece of capture context information about a land portion.

11. The method according to claim 10, characterized in that the method further comprises a step (70) of generating at least one piece of context information about an overflown land portion, and in that
the comparison step (72) compares said at least one piece of context information about the overflown land portion with at least one memorized piece of context information about at least the previous captured image to determine the rate of overlapping of the overflown land portion with at least the previous captured image.

12. The method according to claim 10, characterized in that the method further comprises a step (78) of memorizing the captured image and its context information generated during the step (70) of generating at least one piece of context information about the overflown land portion.

13. The method according to claim 10, characterized in that the context information comprises a piece of geolocation information and/or the speed of displacement of the camera unit and/or the angle of view of the camera and/or the orientation of the camera and/or the distance between the camera and the ground.

14. The method according to claim 13, characterized in that it further comprises, before the take-off of the drone, a step of determining the initial distance between the camera and the ground by estimating the altitude of said camera unit, and
during the flight of the drone, at least one step of determining the distance between the camera and the ground of the overflown land portion by difference between the initial distance and the estimated distance of the altitude of said camera unit.

15. The method according to claim 13, characterized in that it further comprises a step of analyzing the images of the camera to produce a horizontal speed signal, derived from an analysis of the displacement of the land portion captured from one image to the following one, and a step of determining the distance between the camera and the ground as a function of said horizontal speed signal.

16. The method according to claim 9, characterized in that the predetermined rate of overlapping is at most of 85% and preferentially of at most 50%.

17. The camera unit according to claim 3, characterized in that the comparison means operate a comparison with a piece of geolocation information and/or the speed of displacement of the camera unit and/or the angle of view of the camera and/or the orientation of the camera and/or the distance between the camera and the ground.

18. The method according to claim 11, characterized in that the method further comprises a step (78) of memorizing the captured image and its context information generated during the step (70) of generating at least one piece of context information about the overflown land portion.
